(19) United States
(12) Patent Application Publication
(10) Pub. No.: US 2021/0013533 A1
(43) Pub. Date: Jan. 14, 2021

(54) SEPARATOR OF A MICROBIAL FUEL CELL

(71) Applicant: OKINAWA INSTITUTE OF SCIENCE AND TECHNOLOGY SCHOOL CORPORATION, Okinawa (JP)

(72) Inventors: Viacheslav FEDOROVICH, Kunigami-gun, Okinawa (JP); Georgy FILONENKO, Delft (NL); Igor GORYANIN, Kunigami-gun, Okinawa (JP); Geoffrey Kellogg SCHAFFER-HARRIS, Kunigami-gun, Okinawa (JP); David James Wilpault SIMPSON, Kunigami-gun, Okinawa (JP); Peter BABIAK, Kunigami-gun, Okinawa (JP)

(73) Assignee: OKINAWA INSTITUTE OF SCIENCE AND TECHNOLOGY SCHOOL CORPORATION, Okinawa (JP)

(21) Appl. No.: 16/968,758

(22) PCT Filed: Feb. 14, 2019
(86) PCT No.: PCT/JP2019/005386

§ 371 Date: Aug. 10, 2020

Related U.S. Application Data
(60) Provisional application No. 62/630,537, filed on Feb. 14, 2018.

(51) Int. Cl. H01M 8/1023; H01M 8/16; H01M 8/1044; H01M 8/1058

(52) U.S. Cl. CPC H01M 8/1023; H01M 8/16; H01M 2008/1095; H01M 8/1058; H01M 8/1044

(57) ABSTRACT

The present invention is related to a separator of a microbial fuel cell comprising: a porous supporting material and a C hydrogel, wherein the hydrogel is introduced in pores of the porous supporting material.

### TECHNICAL FIELD

The present invention relates to a separator of a microbial fuel cell and a microbial fuel cell with the same.

### BACKGROUND ART

Microbial fuel cells (MFC) are devices, which converts chemical energy of compounds into electricity (Non Patent Literature 1). Contrary to chemical fuel cells, in MFC various types of separation of anodic and cathodic zones can be used. The first option is to divide these zones by porous separator (Non Patent Literature 2), which may be represented by either ultrafiltration polymeric membrane or rigid materials like porous graphite (Non Patent Literature 1). The application of these materials increases the current in MFC but sufficiently reduce the efficiency of the transformation of the fuel into electricity because of mutual depolarization due to penetration of reduced compounds into cathodic zone and oxidized ones to anodic zone. The second option is to use existing types of ion exchange polymeric membranes akin to Nafion type membranes (Non Patent Literature 3). However, these membranes, in solid or in liquid form, are very expensive in the case of large scale MFC and can comprise up to 40% of the total costs of MFC. The most promising polymers, which can substitute existing ion exchange membranes are ion exchange hydrogels (Non Patent Literature 4) which contain sulfonic acid groups in the case of proton exchange polymer or quaternary ammonium groups in the case of anion exchange polymer. Membranes used for chemical fuel cells can not readily be used for MFC due to the significant difference in the working conditions of chemical fuel cells (Non Patent Literature 1) and MFCs. In the case of MFC the temperature range of liquid phase is about does not exceed 40° C. and pH range is 5-8.

### CITATION LIST

### Non Patent Literature

NPL 1: Book B. Logan. “Microbial fuel cells”, Willey, 1-200 pp. ISBN-13: 978-0470239483
NPL 2: Bioresource Technology 102 (2011) 244-252.
NPL 3: Phys. Chem. B, 2000, 104 (18), pp 4471-4478
NPL 4: Advanced Materials. 2003, 15, No. 14, 1155-1158.

### SUMMARY OF INVENTION

### Technical Problem

An object of the present invention is to provide a separator of a microbial fuel cell with high currents and low internal resistance.

### Solution to Problem

The separator of a microbial fuel cell of the present invention comprises a porous supporting material and a hydrogel, wherein the hydrogel is introduced in pores of the porous supporting material.

Namely, the present invention relates to the following.

(1) A separator of a microbial fuel cell comprising:

a porous supporting material and

a hydrogel,

wherein the hydrogel is introduced in pores of the porous supporting material.

(2) The separator according to (1), wherein the hydrogel has an interpenetrating polymer network comprising at least two or more polymer networks.

(3) The separator according to (2), wherein the hydrogel possesses ion exchange properties.

(4) The separator according to (3), wherein the hydrogel possesses cation exchange properties.

(5) The separator according to (4), wherein one of the polymer networks is formed by polymerization of negatively charged monomers.

(6) The separator according to (5), wherein the negatively charged monomer is 2-acrylamido-2-methylpropanesulfonic acid.

(7) The separator according to (3), wherein the hydrogel possesses anion exchange properties.

(8) The separator according to (7), wherein one of the polymer networks is formed by polymerization of positively charged monomers.

(9) The separator according to (8), wherein the positively charged monomer is at least one selected from (3-acrylamidopropyl)trimethylammonium chloride, diallyldimethylammonium chloride, (vinylbenzyl)trimethylammonium chloride, [2-(acryloyloxy)ethyl]trimethylammonium chloride and 1-vinylimidazole.

(10) The separator according to any one of (1) to (9), wherein one of the polymer networks is formed by polymerization of monomers being acrylic acid or derivatives thereof.

(11) The separator according to (10), wherein the derivative of acrylic acid is acrylamide.

(12) The separator according to (10) or (11),

wherein the ratio of molar amounts of the negatively or positively charged monomer to the monomer being acrylic acid or derivatives thereof is from 1:1 to 1:4.

(13) The separator according to any one of (10) to (12),

wherein one of the polymer networks is formed by polymerization of negatively or positively charged monomers with a cross-linker of an amount of 2 to 8 mol % to the negatively or positively charged monomers; and

one of the polymer networks is formed by polymerization of monomers being acrylic acid or derivatives thereof with a cross-linker of an amount of 0.2 to 0.8 mol % to the monomers being acrylic acid or derivatives thereof.

(14) A microbial fuel cell comprising:

an anode;

a cathode; and

the separator according to any one of (1) to (13),

wherein the separator is located between the anode and the cathode.

### Advantageous Effects of Invention

The present invention can provide a separator of a microbial fuel cell with high currents and low internal resistance.

### BRIEF DESCRIPTION OF DRAWINGS

FIG. 1(A-C) shows the results of electrochemical tests for the cation exchange separators and cation exchange membrane.

FIG. 2(A-D) shows the results of electrochemical tests for the anion exchange separator and anion exchange membrane.

FIG. 3 shows the results of internal resistances tests for the cation exchange separators.

### DESCRIPTION OF EMBODIMENTS

<Terms>

To simplify the comparison of the present invention with others, technical terms, which will be used here, will be defined in the same way as those in related patent WO2006013612 (A1). The term “first network structure” refers to a network structure formed first during production while the term “second network structure” refers to a network structure formed afterwards within the first network, and the term “first monomer component” refers to a material for the first network structure while the term “second monomer component” refers to a material for the second network structure. The term “degree of crosslinking” refers to the molar content of a cross-linker with respect to charged monomer, which is expressed in percent.

In the present invention, the term “separator of a microbial fuel cell” refers to a separator used for a microbial fuel cell, and used for separating the anodic zone and cathodic zone in the microbial fuel cell. The separator may be located between an anode and a cathode of the microbial fuel cell.

<Separator of a Microbial Fuel Cell>

The separator of a microbial fuel cell of the present invention comprises a porous supporting material and a hydrogel, wherein the hydrogel is introduced in pores of the porous supporting material.

The separator of a microbial fuel cell of the present invention is characterized in that a hydrogel is introduced in pores of aporous supporting material. Because the hydrogel can swell in pores of the porous supporting material, for example, the hydrogel can completely cover the surface of the separator, and the hydrogel can make contact with the catalyst and interacts readily with the volume of wastewater. Furthermore, this character of the present separator can protects the separator from pressing out of the hydrogel from the porous supporting material.

(Porous Supporting Material)

In the present invention, the porous supporting material can be any hydrophilic material as long as it is enough rigid to support the hydrogel and has pores which the hydrogel can be introduced into.

The porous supporting material includes porous graphite (after hydrophilization), porous glass, porous stainless-steel porous ceramics and the like, preferably porous ceramics.

(Hydrogel)

In the present invention, the hydrogel means a hydrophilic polymer containing a large amount of water. The separator of the present invention comprises a hydrogel.

The hydrogel may have, for example, an interpenetrating polymer network (IPN). In the case of the hydrogel having an interpenetrating polymer network, the hydrogel has high mechanical strength. Furthermore, the hydrogel may possess ion exchange properties. The ion exchange properties may be cation exchange properties or anion exchange properties. Because the hydrogel can exchange cations or anions, for example, the separator of the present invention can repress depolarization.

In the present invention, the interpenetrating polymer network means a polymer comprising two or more networks that are at least partially interlaced on a molecular scale but not completely covalently bonded to each other and cannot be separated unless chemical bonds are broken. The interpenetrating polymer network (IPN) is distinguished from a semi-interpenetrating polymer network (semi-IPN) which is a polymer comprising one or more polymer networks and one or more linear or branched polymers characterized by the penetration on a molecular scale of at least one of the networks by at least some of the linear or branched macromolecules. These definitions further distinguish a semi-interpenetrating polymer network (semi-IPN) from an interpenetrating polymer network (IPN) by the fact that the former is a mixture of a polymer and a polymer network which can be separated by physical means. The polymeric crosslinking which occurs during the formation of an interpenetrating polymer network entangles the constituent polymers in such a manner that they can only be separated by breaking chemical bonds.

In the present invention, a polymer network which the interpenetrating polymer network (IPN) comprises may be at least two or more polymer networks. One of the polymer networks may be, for example, formed by polymerization of negatively charged monomers or positively charged monomers. In the case of one of the polymer networks is formed by polymerization of negatively charged monomers, the hydrogel possesses cation exchange properties. In the case of one of the polymer networks is formed by polymerization of positively charged monomers, the hydrogel possesses anion exchange properties.

The negatively charged monomers includes acrylic acid, methacrylic acid, 2-acrylamido-2-methylpropanesulfonic acid and the like, preferably 2-acrylamido-2-methylpropanesulfonic acid.

The positively charged monomers includes: (vinylbenzyl)trimethylammoniumchloride, [2-(acryloyloxy)ethyl]trimethylammonium chloride and 1-vinylimidazole, diallyl dimethyl ammonium chloride, (3-Acrylamidopropyl)trimethylammonium chloride and the like, preferably diallyl dimethyl ammonium chloride and (3-Acrylamidopropyl)trimethylammonium chloride.

In the present invention, one of the polymer networks may be a neutral polymer network, for example, formed by polymerization of monomers being acrylic acid or derivatives thereof, preferably, acrylamide. For example, the neutral polymer network can give strength to the hydrogel.

In the present invention, the hydrogel having an interpenetrating polymer network may be a double-network hydrogel (DN gel). The DN gel is, for example, known as a new class of hydrogels with sufficiently higher mechanical and ion exchange properties, in which a high relative molecular mass neutral polymer network (second network) is incorporated within a swollen heterogeneous polyelectrolyte network (first network). The mechanical properties of DN gels prepared from many different polymer pairs are shown to be much better than that of the individual components. The DN gels with optimized composition, containing about 90 wt % water, possess hardness (elastic modulus of 0.1-1.0 MPa), strength (failure tensile stress 1-10 MPa, strain 1000-2000%; failure compressive stress 20-60 MPa, strain 90-95%).

Although this double network structure has been found effective to many kinds of combination, among all the polymer pairs the inventors studied so far, the one containing poly (2-acrylamido, 2-methyl, 1-propanesulfonic acid) (PAMPS) polyelectrolyte and polyacrylamide (PAAm) neutral polymer stands out due to unusually properties.

The strength of DN gel increases when the molar content of the second network with respect to the first network increases. The mechanical behavior of the DN gel sufficiently changes with the variation of the cross-linker density of the second network, even if all the PAMPS/PAAm DN gels show almost the same elastic modulus, water content, and molar ratio of the second network to the first network. Recent work (Macromolecules, 2009, 42, 2184) showed that when the first PAMPS gel was synthesized, some divinyl-crosslinker-methylenebis(acrylamide) (MBAA) reacted only on one side and un-reacted double bonds were still intact in the first PAMPS gel. Therefore, when the second PAAm network was prepared, the AAm monomers of the second network could react with the remaining double bonds of the first network. Therefore, typical DN gels have inter-cross-linked (connected) double network structure, and usual DN gels reached a high strength even without adding any cross-linker of the second network by the inter-connection between the two networks through covalent bonds.

<Preparation of the Separator of a Microbial Fuel Cell>

The separator of a microbial fuel cell of the present invention may be prepared, for example, as follows. Here, DN gel is used for the hydrogel.

First: any porous material with the porosity up to 70% may be used as a porous supporting material. The DN gel with ion-exchange properties is incorporated into the porous supporting material via the following steps;

The first net is created, for example, by using of a charged unsaturated monomer where the content of this monomer in the final double net polymer varies from 10 to 50 mol %. In the case of the cation exchange separator, the 2-acrylamido-2-methylpropane sulfonic acid (AMPS) monomer may be used to prepare the first network. In the case of the anion exchange separator, the diallyl dimethyl ammonium chloride or (3-Acrylamidopropyl)trimethylammonium chloride or [2-(acryloyloxy)ethyl]trimethylammonium chloride monomers may be used to prepare the first network.

Second: an electrically neutral unsaturated monomer may be used as a second monomer component where the content of this monomer in the final double network polymer varies from 50 to 90 mol %. For cation exchange separators, the monomers like acrylamide (AAm), acrylic acid (AA), methacrylic acid, and their derivatives may be used.

The porous supporting materials for a microbial fuel cells are typically not transparent for ultraviolet irradiation. Moreover the second requirement is that double net polymers of separator should swell in water. This restriction influences the choice of polymerization initiator, crosslinker, and activator and solvent.

Polymerization initiators and activators to be used for forming the first and second network structures are not limited and a variety of them may be used depending on organic monomers to be polymerized. However a water-soluble thermal initiators such as potassium persulfate or ammonium peroxydisulfate (APS) may be preferably used as initiators in the case of thermal polymerization in combination with tetramethylethylenediamine (TEMED) as activator.

The preferable cross-linker for the present invention is N, N′-methylenebisacrylamide (MBAA).

The value of conductivity can be varied, for example, by the amount of cross-linker in the first network.

The swelling property of DN hydrogels can be varied, for example, in the wide range (50%-200%). This property makes it possible to apply mechanical treatment to the porous supporting material (like ceramics) when DN hydrogel is in the dry state inside the pores of the supporting material. After treatment, the porous supporting material is immersed in the liquid phase, then, the DN hydrogel partially go out of the pours of the porous supporting material and completely cover the surface of the separator. The covering of the surface is useful for protecting the separator from pressing out of the DN hydrogel from the separator, especially when the separator is used for a microbial fuel cell whose height is around 10-15 m. This height corresponds to the liquid pressure of 101 kP-152 kP. The variation of swelling property and rigidity of the final polymer can be control, for example, by the concentration of the monomer in the second network and the amount of cross-linker in the second network.

<Microbial Fuel Cell>

The microbial fuel cell of the present invention comprises an anode; a cathode; and the separator of the present invention, wherein the separator is located between the anode and the cathode.

The microbial fuel cell of the present invention is characterized in that the separator of a microbial fuel cell is the separator of the present invention, and other configurations and conditions are not particularly limited. The microbial fuel cell may be, for example, known microbial fuel cells.

In the present invention, as a general configuration of a microbial fuel cell, the following configuration can be exemplified.

A microbial fuel cell includes, as main components, an anode, a cathode, a separator, and a container for containing a liquid phase fuel. The cathode and the anode are electrically connected to each other via an external circuit and are disposed in the container. The separator is disposed between the anode and the cathode. Thus, the inside of the container is partitioned into a cathode side and an anode side by the separator. The separator may be the separator of the present invention as described herein. The anode, the cathode and the container may be, for example, those conventionally used in microbial fuel cells. The anode-side compartment is filled with liquid phase fuel, for example, in operation of the microbial fuel cell, i.e., in power generation. The liquid phase fuel may be, for example, a wastewater containing organic compounds. As the catalyst of the anode, a microorganism, for example, an anaerobic microorganism, is used. The microorganisms may, for example, be added to the anode-side compartment as microbial sludge, for example anaerobic sludge.

While both the anode-side compartment and the cathode-side compartment in the above-mentioned microbial fuel cell are in a liquid phase in operation, the configuration is not limited. For example, the cathode-side compartment may be in a gas phase. A cathode having such a cathode-side compartment may be referred to, for example, as an “air cathode”. In this case, for example, the separator and the cathode are integrated, and the anode-side compartment containing the liquid phase fuel and the cathode-side compartment of the gas phase are separated by the separator.

### EXAMPLES

The present invention will be described below in more detail by showing examples, but the present invention is not intended to be limited by the following examples.

All chemicals were purchased from WACO Pure Chemicals; Potentiostate “INTERFACE 1000E” manufactured by GAMRY INSTRUMENTS company (USA) was used for chronoamperometry method. Comparative tests were carried out using membrane Nafion™ (DuPont corporation USA) for comparison with DN cation exchange polymers and membrane AMI-7001CR (Membranes International USA) for comparison with DN anion exchange polymers.

<General Description of Electrochemical Tests and Grouping of Results>

Porous Supporting Materials, Polymerization Reactor and Electrochemical Cell for Testing

The porous supporting material for ion exchange separators were plates of porous ceramics of 50% porosity (Jiangso Ceramic, China) and plates of porous plastic of 70% porosity (Yamahachi Chemical, Japan). The size of all plates was 97 mm×75 mm×3.3 mm.

The polymerization reactor was made from acrylic glass with the thickness of the 8 mm wall thickness. The internal volume has rectangular shape with the height of 50 mm and the bottom area of 100 mm×80 mm. The upper lid of the reactor had 2 taps for filling of reactor with nitrogen gas and oxygen removal.

The electrochemical cell for testing of separators has two chambers in the form of hollow cylinder with one closed side and an open opposite side with a flange at the end. The aperture of the flange was equal to the external diameter of the cylinder. Each flange had a rubber ring glued to the surface of the last one. The volume of each chamber was 50 mL. Each chamber contained stainless steel electrode in the form of cylinder (length 4 cm, diameter 0.4 cm). The aperture of each flange was 20 cm². In the case of test for cation exchange separators, each chamber has identical (length 5 cm, diameter 0.5 cm) stainless steel electrodes. In the case of test for anion exchange separators, each chamber has non-porous graphite disk (5 cm diameter×0.4 cm thickness) as an electrode. Each chamber also has an orifice for reference electrode and for filling appropriate electrolyte solution. The ion exchange separator was pressed between rubber rings located on each flange.

The result of each electrochemical test was a curve which represented dynamics of a current in time for each ion. Tests for different separators with different hydrogels were grouped in examples. One example contained different current curves obtained for one ion. Comparative examples with commercial membranes contained one curve for each ion.

1. Cation Exchange Separators (Examples 1-3)

(Preparations of the Solutions for Hydrogels)

Solution for the First Network Gel of the Hydrogel (used for Example 1, Polymer with 2% M Crosslinker)

14 mL of deionized water at 4° C. as a solvent were purged with nitrogen for deoxygenation for 15 minutes. Then 2.9 gram of 2-acrylamido-2-methylpropane sulfonic acid (AMPS) as a first monomer was dissolved in 14 mL of deionized water (1M solution), then 43 mg (2% M) of N,N′-methylenebisacrylamide (MBAA) as a crosslinker was added and dissolved in the previous solution, then 32 mg of ammonium peroxy-disulfate (APS) (1% M) as initiator was dissolved in previous solution, then 40 microliters of tetramethylethylenediamine (TEMED) as activator was added to the previous solution and the mixture was shaken several times.

Solution for the First Network Gel of the Hydrogel (used for Example 2, Polymer with 4% M Crosslinker)

14 mL of deionized water at 4° C. as a solvent were purged with nitrogen for deoxygenation for 15 minutes. Then 2.9 gram of 2-acrylamido-2-methylpropane sulfonic acid (AMPS) as a monomer was dissolved in 14 mL of deionized water (1M solution), then 86 mg (4% M) of N,N′-methylenebisacrylamide (MBAA) as a crosslinker was added and dissolved in the previous solution, then 32 mg of ammonium peroxydisulfate (APS) (1% M) as initiator was dissolved in previous solution, then 40 microliters of tetramethylethylenediamine (TEMED) as activator was added to the previous solution and the mixture was shaken several times.

Solution for the First Network Gel of the Hydrogel (used for Example 3, Polymer with 8% M Crosslinker)

14 mL of deionized water at 4° C. as a solvent were purged with nitrogen for deoxygenation for 15 minutes. Then 2.9 gram of 2-acrylamido-2-methylpropane sulfonic acid (AMPS) as a monomer was dissolved in 14 mL of deionized water (1M solution), then 172 mg (8% M) of N,N′-methylenebisacrylamide (MBAA) as a crosslinker was added and dissolved in the previous solution, then 32 mg of ammonium peroxydisulfate (APS) (1% M) as initiator was dissolved in previous solution, then 40 microliters of tetramethylethylenediamine (TEMED) as activator was added to the previous solution and the mixture was shaken several times.

Solution for the Second Network Gel

14 mL of deionized water at 4° C. were deoxygenation by purging with N₂ gas for 15 minutes. 2 grams of acrylamide (AAm) as a second monomer was dissolved in 14 mL of deionized water (2 M). Then 10 mg of N,N′-methylenebisacrylamide (MBAA) as a crosslinker was added and dissolved in the previous solution (0.2% M). After that 32 mg of ammonium peroxydisulfate (APS) as initiator and 40 microliters of tetramethylethylenediamine (TEMED) as activator was added to the previous solution.

(Preparations of the Cation Exchange Separators (Examples 1-3))

Each flat ceramic plate was placed on the bottom of polymerization reactor and completely covered by appropriate solution for the first network gel. Then the reactor was put into oven at the temperature of 60° C. for 24 hours. Thus, three ceramic plates, which contained three different first network gels, were prepared.

Then, the solution for the second network gels was introduced in the polymerization reactor, which contained ceramic plate impregnated by the first polymer net, in such a way that the solution with second monomer completely covered the surface of ceramics. Then, the reactor was left for 24 hours. Penetration of the solution for the second network gel into the structure of the first polymer located in the pours of ceramic plate occurs.

These hydrogels were prepared with a molar ratio of the first net to second net as 1/2.

(Electrochemical Tests of Cation Exchange Separators)

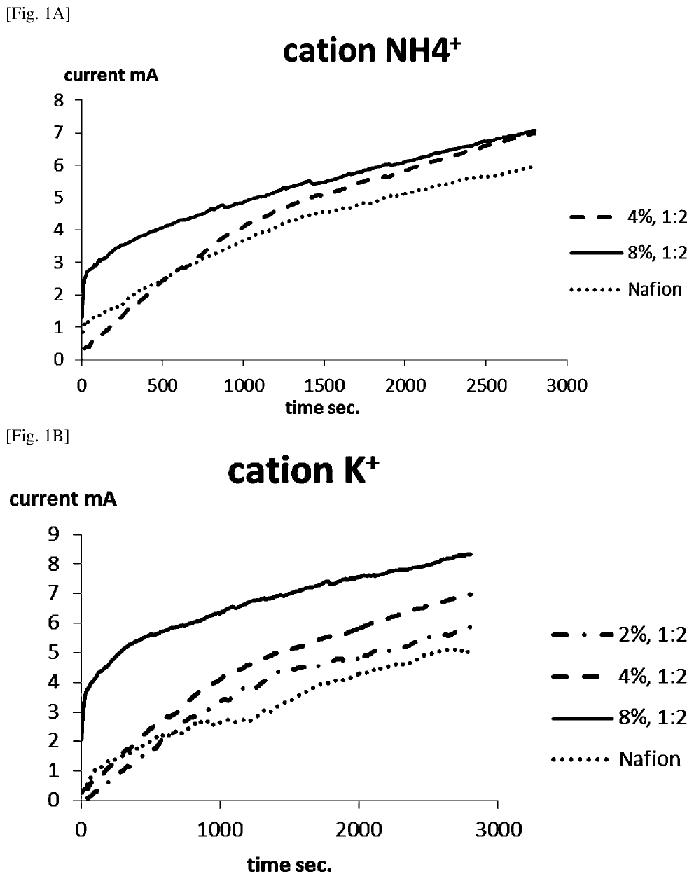

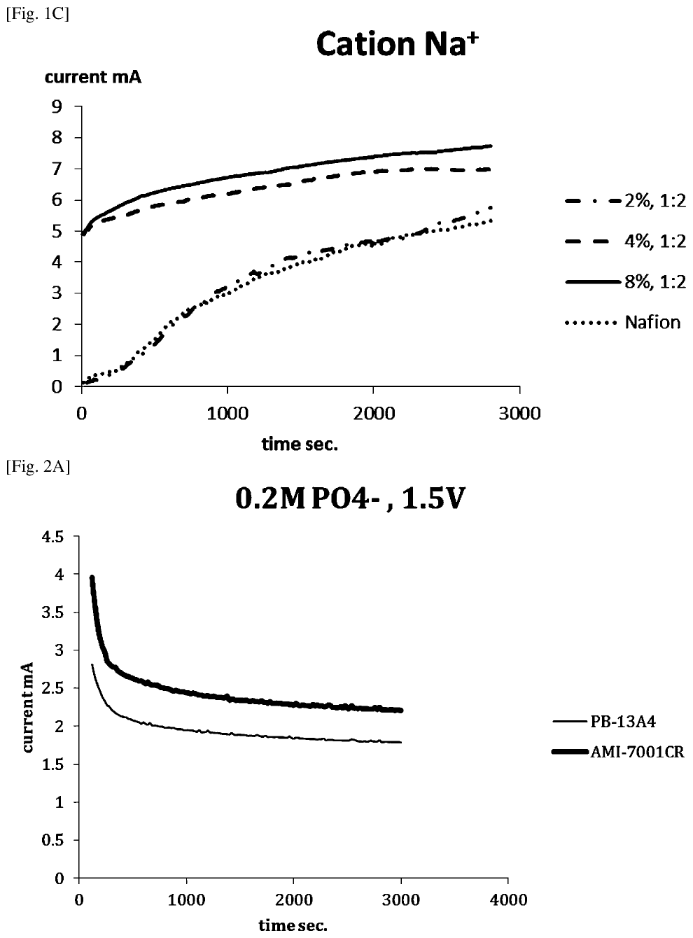

Before testing each separator was pressed between rubber rings located on the surface of flanches of cylinder. Then both cylinders were filled with appropriate electrolyte and chronoamperometry method was applied for comparison of the currents corresponding to the fluxes of different cations thru separator. Chronoamperometry was realized using two electrode system where the voltage between anodic and cathodic electrode was equal to 0.5V. Three types of electrolytes were used: 0.1M NH₄ Cl in deionized water concentration (FIG. 1A), 0.1M KCl in deionized water concentration (FIG. 1B), 0.1M NaCl in deionized water concentration (FIG. 1C).

Cation exchange polymers (examples 1-3) were prepared as described above. They differ only by concentration of cross-linker in the first network gel. The amounts of cross-linker in the first net were 2% M, 4% M, and 8% M with respect to the concentration of 100% M of initial charged monomers. All components in the second network were identical in all three separators. The molar ratio of the monomers in the first net to the monomers in the second net was 1M/2M.

Comparative examples 1-3 for the same three types of electrolytes were created. The electrochemical cell was the same as in examples 1-3. The cell contained porous ceramics plate of 50% porosity, identical to ceramic plates that were used as supporting materials for examples 1-3. One side of the plate was covered by foliate-type ion exchange membrane—Nafion 117.

FIGS. 1A-C contain information about the values of currents generated by different cations and for different separators (examples 1-3 and comparative examples 1-3). Legends to figures on FIGS. 1A-C show the molar percentage of cross-linker and molar ratio of the first monomer to the second one. As shown in FIG. 1A-1C, currents for examples 1-3 are higher in comparison with a comparative example (with widely used cation exchange membrane Nafion-117).

2. Anion Exchange Separators (Examples 4-6)

(Preparations of the First Network Gel of the Hydrogels)

Preparation of the First Network Gel of the Hydrogel (used for Example 4, First Net for Polymer PB-13/A4)

25 mL of diallyldimethylammonium chloride (monomer) 4M stock solution and N-[(acryloylamino)methyl]acrylamide (crosslinker) 154 mg was solubilized in 75 mL of deionized water. Solution was cooled to 4° C. and sparged with nitrogen for 15 min. Then ammonium persulfate (radical initiator) 456 mg was added and solubilized. Air in porous ceramic (Jiangsu ceramic) was exchanged by nitrogen in exicator by applying vacuum and then filled with nitrogen. Procedure was repeated 3 times. Then porous ceramic was cooled to 4° C. and dipped to cooled solution of monomer with crosslinker and radical initiator. Vacuum was applied for 1 h to fill all pores with solution. Cold temperature (4° C.) was maintained during process. Then vacuum was replaced by nitrogen atmosphere and porous ceramic in solution of monomer with crosslinker and radical initiator was heated to 60° C. for 24 h. After 24 h of heating porous ceramic was cooled to room temperature. Excess of gel was scraped out of porous ceramic. Porous ceramic with 1^{st} polymer was cooled to 4° C.

Preparation of the First Network Gel of the Hydrogel (used for Example 5, First Net for Polymer PB-13/B2)

25 mL of diallyldimethylammonium chloride (monomer) 4M stock solution and N-[(acryloylamino)methyl]acrylamide (crosslinker) 77 mg was solubilized in 75 mL of deionized water. Solution was cooled to 4° C. and sparged with nitrogen for 15 min. Then ammonium persulfate (radical initiator) 456 mg was added and solubilized. Air in porous ceramic (Jiangsu ceramic) was exchanged by nitrogen in exicator by applying vacuum and then filled with nitrogen. Procedure was repeated 3 times. Then porous ceramic was cooled to 4° C. and dipped to cooled solution of monomer with crosslinker and radical initiator. Vacuum was applied for 1 h to fill all pores with solution. Cold temperature (4° C.) was maintained during process. Then vacuum was replaced by nitrogen atmosphere and porous ceramic in solution of monomer with crosslinker and radical initiator was heated to 60° C. for 24 h. After 24 h of heating porous ceramic was cooled to room temperature. Excess of gel was scraped out of porous ceramic. Porous ceramic with 1^{st} polymer was cooled to 4° C.

Preparation of the First Network Gel of the Hydrogel (used for Example 6, First Net for Polymer PB-13/B5)

25 mL of diallyldimethylammonium chloride (monomer) 4M stock solution and N-[(acryloylamino)methyl]acrylamide (crosslinker) 77 mg was solubilized in 75 mL of deionized water. Solution was cooled to 4° C. and sparged with nitrogen for 15 min. Then ammonium persulfate (radical initiator) 456 mg was added and solubilized. Air in porous plastic (Yamahachi Chemical) was exchanged by nitrogen in exicator by applying vacuum and then filled with nitrogen. Procedure were repeated 3 times. Then porous plastic was cooled to 4° C. and dipped to cooled solution of monomer with crosslinker and radical initiator. Vacuum was applied for 1 h to fill all pores with solution. Cold temperature (4° C.) was maintained during process. Then vacuum was replaced by nitrogen atmosphere and porous plastic in solution of monomer with crosslinker and radical initiator was heated to 60° C. for 24 h. After 24 h of heating porous plastic was cooled to room temperature. Excess of gel was scraped out of porous plastic. Porous plastic with 1^{st} polymer was cooled to 4° C.

(Introduction of the Second Monomer and Preparations of the Anion Exchange Separators)

The procedure of introduction of the second monomer and further polymerization are the same for examples 4-6. Acrylamide (monomer) 14.2 g and N-[(acryloylamino)methyl]acrylamide (crosslinker) 92.4 mg were solubilized in 100 mL of deionized water and solution was cooled to 4° C. and sparged with nitrogen for 15 min. Then ammonium persulphate (radical initiator) 912 mg was added and solubilized. Porous ceramic with 1^{st} polymer was dipped to cooled solution of monomer with crosslinker and radical initiator for 24 h. Cold temperature (4° C.) was maintained during process. After 24 h of swelling porous supporting material in solution of monomer with crosslinker and radical initiator was heated to 60° C. for 24 h. After 24 h of heating porous ceramic was cooled to room temperature. Excess of gel was scraped out of porous ceramic and membrane was ready for use.

(Electrochemical Tests of Anion Exchange Separators)

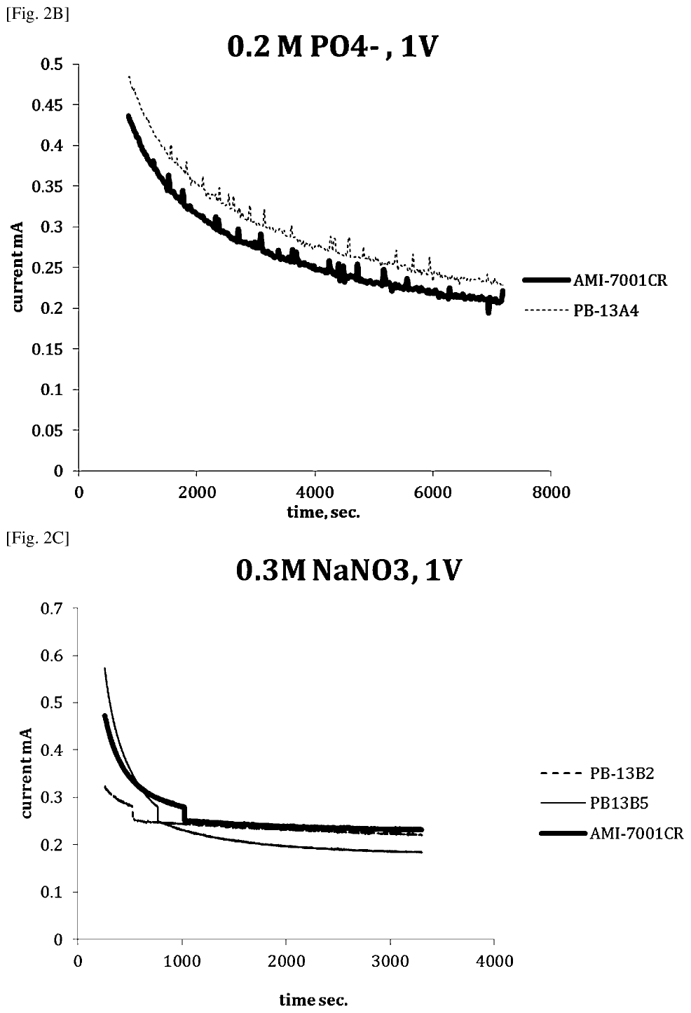

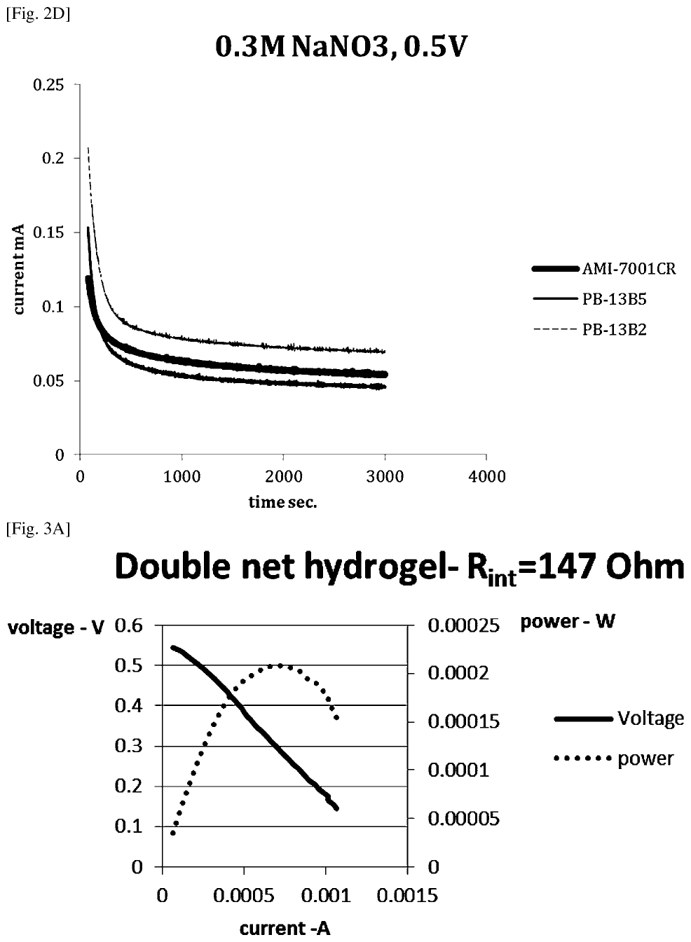

Electrochemical tests were carried out using the same electrochemical cell as for testing cation exchange separators. Chronoamperometry was realized using two electrode system where voltages varied from 0.5 V up to 1.5V. Both anodic and cathodic chambers of the cell were filled with the equal molarity solutions. Electrolytes that were used in tests were 0.2M sodium phosphate (FIG. 2A, B) and 0.3M sodium nitrate (FIG. 2C, D).

Comparative examples 4-6 were created. Electrochemical cells contained porous material plates, identical to plates that were used as supporting materials for examples 4-6. One side of the plate was covered by anion exchange membrane AMI-7001 CR.

FIGS. 2A-D contain the dynamics of currents in time produced by the transport of nitrate and phosphate ions between anodic and cathodic zones thru three types of separators (examples 4-6) and comparative examples (AM-7001CR).

FIGS. 2C-D show that the conductivity of membrane AMI-7001 CR and hydrogel membranes (examples 5-6) were almost the same (differ by the 10%).

3. Microbial Fuel Cell Internal Resistance Tests

Internal resistances of microbial fuel cell with two different separators were measured by means of liner sweep voltammetry.

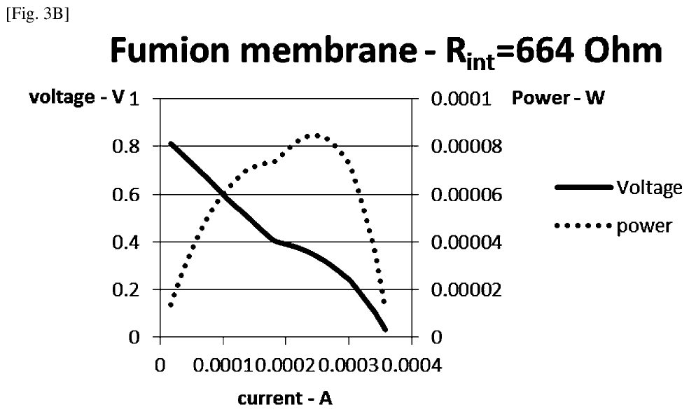

The microbial fuel cell for this test consisted of one anodic chamber which had the volume 150 mL, inoculated with anaerobic sludge, and two identical air breezing cathodic electrodes attached to both sides of anodic chamber. The first cathodic electrode was separated from anodic zone by means of the separator (example 7, FIG. 3A) based on cation exchange hydrogel impregnated in porous ceramic plate whilst the second cathodic electrode was separated from the same anodic zone by the separator which was porous graphite plate of the same size covered by cation exchange polymer Fumion™, which is an analog of Nafion-117 (comparative example 7, FIG. 3B).

(Measurement of Internal Resistances of Example 7 and Comparative Example 7)

To produce example 7, a cation exchange separator (ceramic plate 60×80×3 mm³-50% porosity impregnated by double net hydrogel) was created by the same way as in example 1 where the molar ratio of the first (charged) monomer to the second (uncharged) monomer was 1:2 and the concentration of cross-linker in the first net was 2%.

For comparative example 7, a porous graphite plate 60×80×3 mm³ (50% porosity) was covered by liquid suspension of ion exchange polymer with the following drying (5% solution of ion exchange polymer—Fumion™ in water (company Fumatech—Germany). The density of covering was 2 mL suspension per 1 cm² of the plate surface.

The information about internal resistances for example 7 and comparative example 7 was taken from polarization curves (voltage vs current). Polarization curves were obtained by linear voltammetry using two electrode system. The sweep rate was 0.01 mV/sec. This sweep rate gave the possibility to keep microbial fuel cell in cvazy-equilibrium state at different values of applied voltage. The obtained experimental voltamograms and calculated power curves are shown on FIG. 3A-3B. The internal resistances for both separators were calculated using the formula:

Rᵢₙₜ=V_{Pmax}/I_{Pmax}/2
Where: V_{Pmax}—voltage for the maximal power generation of microbial fuel cell,
   I_{Pmax}—current for the maximal power generation of microbial fuel cell

Factor 2 appeared in the formula because the maximal power is generated when the external resistance generated by potentiostate is equal to internal one.

As it follows from the curves on FIG. 3A-3B and the formula, the internal resistance for the case when anodic and cathodic zones were separated by example 7 was 4.5 times less than for the case when zones were separated by comparative example 7. The values of internal resistances were 147 Ohms and 664 Ohms respectively.

1. A separator of a microbial fuel cell comprising:
a porous supporting material and
a hydrogel,
wherein the hydrogel is introduced in pores of the porous supporting material.

2. The separator according to claim 1, wherein the hydrogel has an interpenetrating polymer network comprising at least two or more polymer networks.

3. The separator according to claim 2, wherein the hydrogel possesses ion exchange properties.

4. The separator according to claim 3, wherein the hydrogel possesses cation exchange properties.

5. The separator according to claim 4, wherein one of the polymer networks is formed by polymerization of negatively charged monomers.

6. The separator according to claim 5, wherein the negatively charged monomer is 2-acrylamido-2-methylpropanesulfonic acid.

7. The separator according to claim 3, wherein the hydrogel possesses anion exchange properties.

8. The separator according to claim 7, wherein one of the polymer networks is formed by polymerization of positively charged monomers.

9. The separator according to claim 8, wherein the positively charged monomer is at least one selected from (3-acrylamidopropyl)trimethylammonium chloride, diallyldimethylammonium chloride, (vinylbenzyl)trimethylammonium chloride, [2-(acryloyloxy)ethyl]trimethylammonium chloride and 1-vinylimidazole.

10. The separator according to claim 2,
wherein one of the polymer networks is formed by polymerization of monomers being acrylic acid or derivatives thereof.

11. The separator according to claim 10, wherein the derivative of acrylic acid is acrylamide.

12. The separator according to claim 10,
wherein the ratio of molar amounts of the negatively or positively charged monomer to the monomer being acrylic acid or derivatives thereof is from 1:1 to 1:4.

13. The separator according to claim 10,
wherein one of the polymer networks is formed by polymerization of negatively or positively charged monomers with a cross-linker of an amount of 2 to 8 mol % to the negatively or positively charged monomers; and
one of the polymer networks is formed by polymerization of monomers being acrylic acid or derivatives thereof with a cross-linker of an amount of 0.2 to 0.8 mol % to the monomers being acrylic acid or derivatives thereof.

14. A microbial fuel cell comprising:
an anode;
a cathode; and
the separator according to claim 1,
wherein the separator is located between the anode and the cathode.
